(19) United States
(12) Patent Application Publication
(10) Pub. No.: US 2025/0293735 A1
(43) Pub. Date: Sep. 18, 2025

(54) Coherent Joint Transmission Channel State Information Codebooks for Multi-Transmission-Reception-Point Operation

(71) Applicant: Apple Inc., Cupertino, CA (US)

(72) Inventors: Haitong Sun, Cupertino, CA (US); Yushu Zhang, Beijing (CN); Dawei Zhang, Saratoga, CA (US); Wei Zeng, San Diego, CA (US); Louay Jalloul, San Jose, CA (US); Ismael Gutierrez Gonzalez, San Jose, CA (US); Ghaith N. Hattab, Santa Clara, CA (US); David Neumann, Munich (DE); Konstantinos Sarrigeorgidis, Los Gatos, CA (US); Anchit Malhotra, Santa Clara, CA (US)

(21) Appl. No.: 18/860,605

(22) PCT Filed: Apr. 28, 2022
(86) PCT No.: PCT/CN2022/089843

§ 371 Date: Oct. 25, 2024

(51) Int. Cl. H04B 7/0456; H04L 27/26

(52) U.S. Cl. CPC H04B 7/0481; H04L 27/265

(57) ABSTRACT

Devices and methods for providing channel state information reporting for multi-transmission-reception-point coherent joint transmission in a wireless communication system. Channel state information configuration information is provided by a base station to a wireless device. The channel state information configuration information indicates one or more restrictions for the UE in reporting a precoding matrix indicator (PMI) for each of multiple transmission reception points. The wireless device provides a PMI to the base station based on the channel state information configuration information.

### PRIORITY INFORMATION

This application is a national stage entry of PCT Application No. PCT/CN2022/089843, entitled “Coherent Joint Transmission Channel State Information Codebooks for Multi-Transmission-Reception-Point Operation,” filed Apr. 28, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for providing a precoding matrix indicator (PMI) for performing coherent joint transmissions for multi-transmission-reception-point operation in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing channel state information reporting for multi-transmission-reception-point (multi-TRP) coherent joint transmission (CJT) operation in a wireless communication system.

According to the techniques described herein, channel state information (CSI) configuration information may be provided to a wireless device that restricts one or more aspects of precoding matrix indicator (PMI) reporting by the UE for different transmission-reception-points (TRPs). The CSI configuration information may include one or both of a codebook subset restriction (CBSR) configuration and a rank restriction, in various embodiments. The CBSR configuration may restrict the UE from providing PMI reporting on particular discrete Fourier transform (DFT) basis groups and/or particular DFT bases within specific DFT basis group(s) for each of the multiple TRPs. The rank restriction may restrict the UE from providing PMI and/or Rank Indicator (RI) reporting for particular ranks for each of the multiple TRPs.

In some embodiments, the determines a PMI based on the CSI configuration information and provides the PMI to the base station.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a matrix equation for a Type II multiple-input multiple-output codebook structure, according to some embodiments;

FIG. 6 is a schematic illustration of four transmission reception points (TRPs) in coherent joint transmission (CJT) communication with a UE, according to some embodiments;

FIG. 7 illustrates oversampling for a beamforming scenario, according to some embodiments;

FIG. 8 is a flowchart diagram illustrating aspects of an exemplary method for performing precoding matrix indicator (PMI) reporting for multi-transmission-reception-point CJT operation in a wireless communication system, according to some embodiments; and

FIG. 9 is a flowchart diagram illustrating aspects of an exemplary method for performing uplink control information omission, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
CJT: Coherent Joint Transmission
CSI: Channel State Information
CSI-RS: Channel State Information Reference Signals
CSI-IM: Channel State Information Interference Measurement
CMR: Channel Measurement Resource
IMR: Interference Measurement Resource
ZP: Zero Power
NZP: Non Zero Power
CQI: Channel Quality Indicator
PMI: Precoding Matrix Indicator
RI: Rank Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

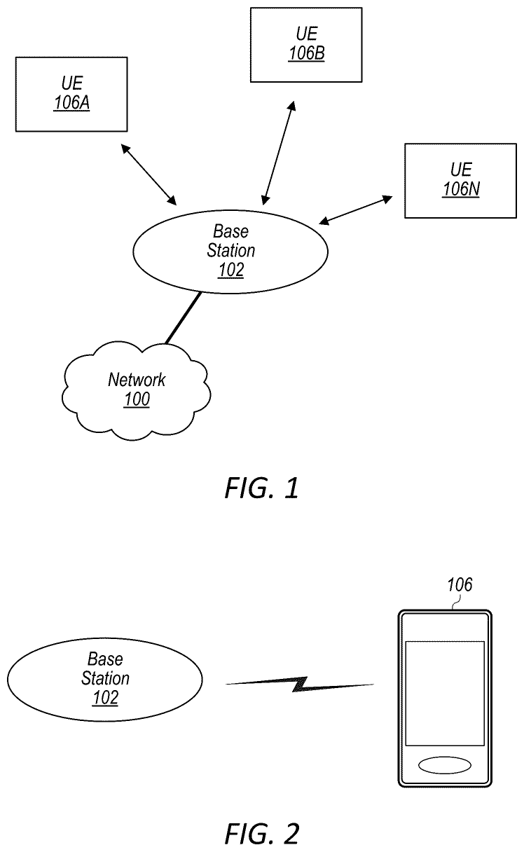

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for performing channel state information reporting for multi-transmission-reception-point operation in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

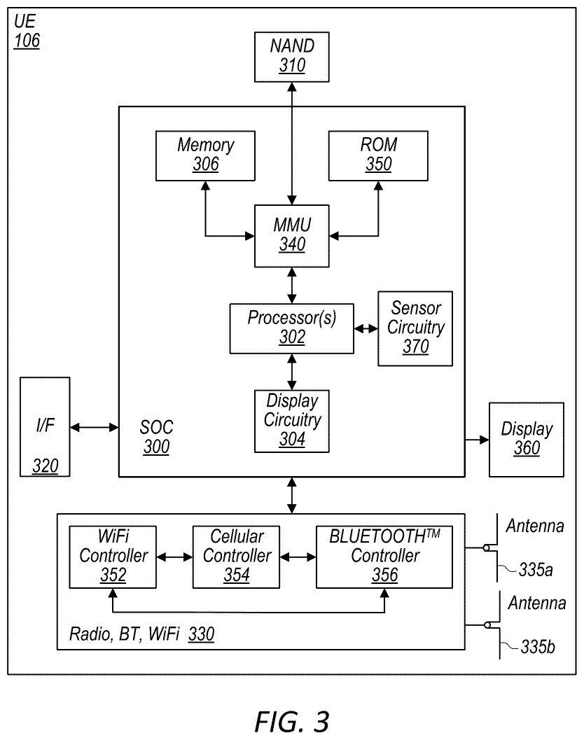

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to perform techniques for performing channel state information reporting for multi-transmission-reception-point operation in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for performing channel state information reporting for multi-transmission-reception-point operation in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

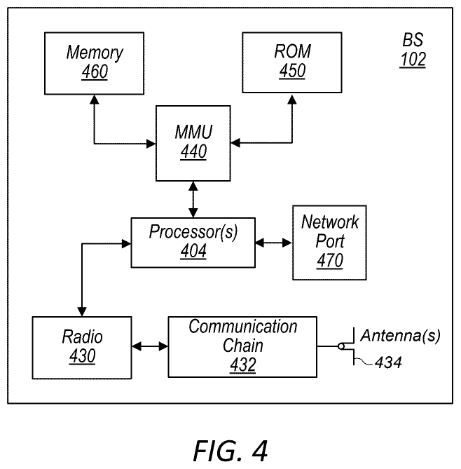

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

### Channel State Information

A wireless device, such as a user equipment, may be configured to measure the quality of the downlink channel and report information related to this quality measurement to the base station. For example, the UE may periodically send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In most cellular systems, the base station transmits a pilot signal (or a reference signal), such as channel state information reference signals (CSI-RS), where this reference signal is used for estimating a channel (or a portion of a channel) between the base station and a UE. The UE receives this reference signal and based on this reference signal calculates channel state information (CSI). The UE then reports this channel state information back to the base station. The base station may then generate downlink data based on the received CSI and transmit this downlink data to the UE. Stated another way, the base station may adjust the manner in which downlink data is coded and generated based on the received channel state information from the UE.

As an example, in the 3GPP NR cellular communication standard, the channel state information fed back from the UE may include one or more of a channel quality indicator (CQI), a precoding matrix indicator (PMI), a rank indicator (RI), a CSI-RS Resource Indicator (CRI), a SSBRI (SS/PBCH Resource Block Indicator), and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a high channel coding rate. As another example, when the downlink channel communication quality between the base station and the UE is determined to be low, the UE may feed back a low CQI value, which may cause the base station to transmit data using a relatively low modulation order and/or a low channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrices) in the codebook. This may enable the UE to reduce the amount of feedback information. Thus, the PMI may indicate which precoding matrix from a codebook is preferred to be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. As used herein, the “rank” of a communication corresponds to the number of layers utilized in the communication. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Ne represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer-to-antenna mapping may be applied, e.g., each layer may be mapped to any number of antenna ports (e.g., antennas). Each antenna port may send and/or receive information associated with one or more layers. The rank may comprise multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### Channel State Information Reporting for Multi-Transmission-Reception-Point Operation

According to some cellular communication technologies, it may be possible for a wireless device to communicate with multiple transmission-reception-points (TRPs), including potentially simultaneously. Such communication can be scheduled using downlink control information (DCI), which may be provided using control signaling such as on a physical downlink control channel (PDCCH) that may be transmitted in one or more control resource sets (CORESETs). The DCI can be provided in a single DCI mode, in which communications between multiple TRPs and a wireless device can be scheduled using a single DCI communication (e.g., from just one TRP), or in a multi-DCI mode, in which each of multiple TRPs can provide DCI communications scheduling their own communications with a wireless device.

The communications that are scheduled in such a multi-TRP scenario can include data communications (e.g., which may be transmitted using a physical downlink shared channel (PDSCH), and/or aperiodic channel state information reference signal (CSI-RS) transmissions, among various possibilities. Further, aperiodic CSI-RS transmissions can include CSI-RS that are configured for multiple possible purposes, such as for beam management, tracking, or CSI acquisition.

Currently, support for CSI reporting for multi-TRP operation remains limited. Improvements in CSI reporting configuration and performance may accordingly improve network and wireless device efficiency, e.g., by providing support for multi-TRP coherent joint transmissions, and/or in any of various other ways.

### Codebooks for Coherent Joint Transmission

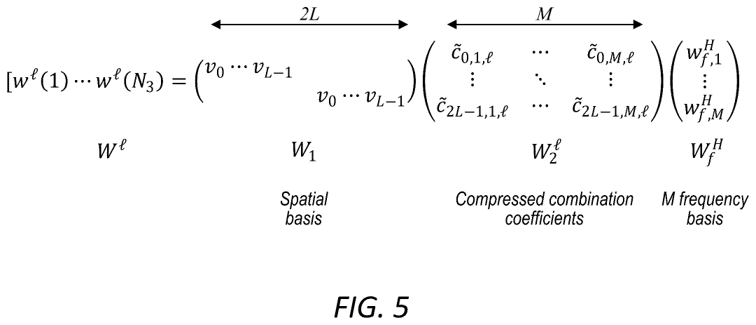

In some embodiments, the Type II MIMO codebook is based on a structure as shown in the Equation illustrated in FIG. 5. In FIG. 5, M is the number of frequency bases, L is the number of spatial bases, N₃ is the number of subbands in the frequency domain (i.e., the number of entries in each frequency basis), and/is the layer index. W₁ is the spatial basis selection matrix, W_{ƒ} is the frequency basis selection function, and W₂ is the combination coefficient matrix.

The Type II MIMO codebook structure has evolved in sequential releases in NR. For example, in Rel-15, Type II and Type II port selection codebooks are specified based on W₁*W₂ (without W_{ƒ}). In Rel-16, enhanced Type II and Type II port selection codebook was introduced and is specified based on W₁*W₂*W_{ƒ} (as in FIG. 5).

Rel-17 introduced a further enhanced Type II port selection codebook. In Rel-17, CSI feedback is further enhanced for Non-coherent Joint Transmission (NCJT) for Multi-transmission-reception point (Multi-TRP) communications. CSI feedback is based on a Type I MIMO codebook, and it supports a Single-DCI Multi-TRP NCJT scheme 1a, i.e., spatial domain multiplexing (SDM).

It is anticipated that in Rel-18 NR, CSI feedback enhancements may be introduced to support Coherent Joint Transmission (CJT) for Multi-TRP communications. CJT involves the Multiple TRPs jointly precoding the transmission in a coherent way. Embodiments herein provide codebook design details and enhancements to support Multi-TRP CJT CSI feedback. In various embodiments, the codebook design is modified to incorporate enhanced Codebook Subset Restriction (CBSR) design, rank restriction design, or uplink control information (UCI) omission design.

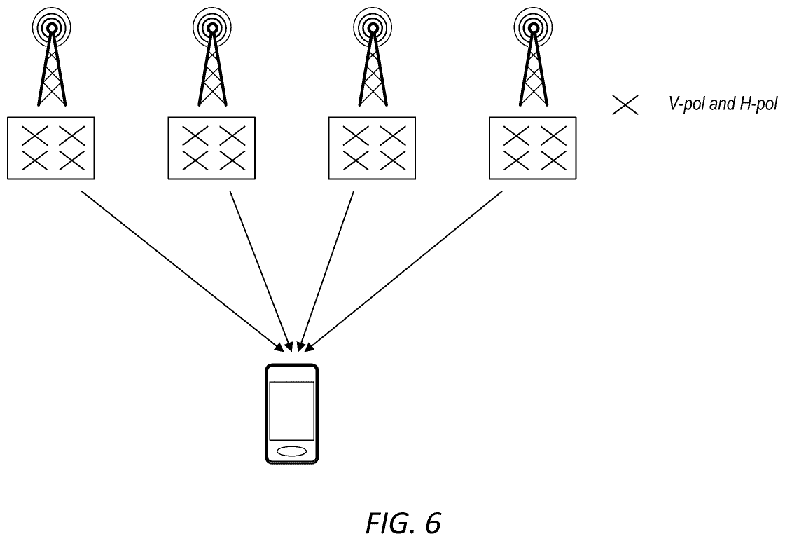

FIG. 6 is a schematic diagram illustrating a multi-TRP communication scenario involving four spatially separated TRPs in communication with a UE. As illustrated, each TRP has 8 ports (i.e., antenna elements), 4 with vertical polarization (V-pol) and 4 with horizontal polarization (H-pol), leading to 32 total ports. In some embodiments, the basic codebook has the structure shown for W in FIG. 6, in which t is the TRP index, the total number of TRPs is T. W^{t} is the Type II CSI codebook reported for TRP with index t, where W^{t} has the same form as is shown in FIG. 5, but is specific to each TRP, i.e., W^{t}=W₁^{t}*W₂^{t}*W_{ƒ}^{t}. The coefficients c^{t} are linear combination coefficients applied to each codebook for different TRPs. The linear combination coefficients {c^{I} . . . c^{T}} apply phase and/or amplitude modulation to transmissions from each TRP to ensure coherency between the different TRP transmissions (e.g., when the TRPs are not collocated, a phase and/or amplitude modulation may be utilized to accommodate for differences in path length and/or channel conditions between different TRPs and the UE).

The Type II codebook supports a 2-dimensional antenna array characterized by N₁*N₂ where N₁ is the number of V-Pol/H-Pol antenna element pairs oriented vertically and N₂ is the number of V-Pol/H-Pol antenna element pairs oriented horizontally (for example, FIG. 6 illustrates TRPs with N₁=2 and N₂=2). The total number of antenna ports is therefore 2*N₁*N₂.

In a multi-TRP CJT scenario, in some embodiments a base station (which may be one of the TRPs of the multi-TRP communication) may provide CSI configuration information to the UE to restrict one or more aspects of the PMI that the UE will provide to the network. In various embodiments, the CSI configuration information may instruct the UE to perform Codebook Subset Restriction (CBSR), rank restriction, or uplink control information (UCI) omission. The CSI configuration information may adjust the CSI feedback to be provided by the UE to better accommodate current radio and/or channel conditions, to reduce the overhead of the CSI feedback, and otherwise to facilitate and/or improve the multi-TRP CJT communications.

In some embodiments, Codebook Subset Restriction (CBSR) is employed, which constrains the UE to report CSI in certain preferred directions, generally to minimize interference with other directions (e.g., inter-cell and/or inter-UE interference). For example, a base station may provide CBSR configuration information to the UE that restricts the UE from reporting CSI on particular beamforming groups.

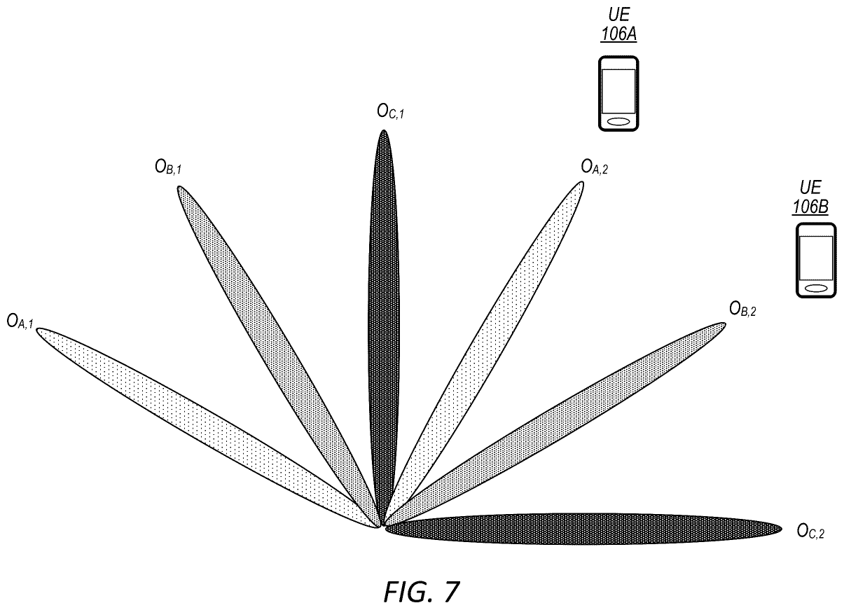

In some multi-TRP CJT deployments, one or more TRPs may deploy oversampling, where the same transmission is transmitted on multiple discrete Fourier transform (DFT) basis groups. For example, FIG. 7 illustrates a simplified 2-dimensional illustration of oversampling and beamforming (beamforming is actually deployed is 3-dimensional space, so FIG. 7 illustrates only a 2-dimensional slice). As illustrated, an oversampling order of 3 is deployed with three oversampling groups (A, B and C), and each oversampling group has two illustrated beams, each corresponding to a distinct DFT basis. UE 106A is well-positioned to receive the O_{A,2} beam, and may preferentially report this beam in a PMI, whereas UE 106B is better positioned to receive the O_{B,2} beam.

For a Type II codebook, the spatial basis is selected from a selected DFT basis group by performing O₁×O₂ oversampling, and may be reported in W₁. Here, O₁ and O₂ represent the degree of oversampling in the vertical and horizontal directions, respectively. In some embodiments, O₁=4 if N₁>1, and otherwise O₁=1. Similarly, O₂=4 if N₂>1, and otherwise O₂=1. There are O₁×O₂ total beam groups, and, each beam groups contains N₁×N₂ orthogonal DFT bases, where each DFT basis contains N₁×N₂ entries. In the case of oversampling, the CBSR configuration may restrict the UE from reporting on particular DFT basis groups (i.e., particular oversampling groups).

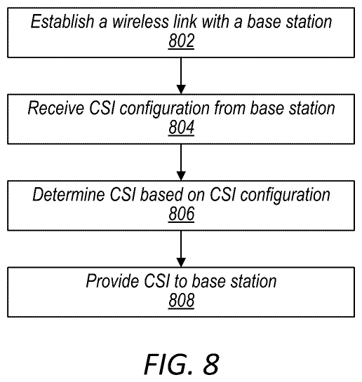

### FIG. 8—Flowchart for CSI Configuration Information in a Multi-TRP CJT Scenario

FIG. 8 is a flowchart diagram illustrating a method for a base station to provide CSI configuration information for use by a UE in providing a PMI in a multi-TRP CJT scenario. Aspects of the method of FIG. 8 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 8 are described in a manner relating to the use of communication techniques and/or features associated with 3GPP and/or NR specification documents, such description is not intended to be limiting to the disclosure, and aspects of the method of FIG. 8 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

In 802, the wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

At 804, a CSI configuration is received from the base station. The CSI configuration may indicate a configuration for the UE to utilize in reporting a precoding matrix indicator (PMI) to the base station as part of a multi-TRP coherent joint transmission (CJT) communication scenario. The CSI configuration may include a codebook subset restriction (CBSR) configuration and/or a rank configuration, according to various embodiments.

The CBSR configuration may indicate one or more permissible discrete Fourier transform (DFT) basis groups for the UE to indicate in a PMI for multi-TRP CJT. Each DFT basis group may correspond to a particular oversampling group, and may include a plurality of respective DFT bases. In some embodiments, the CBSR configuration is a bitmap indicating permissible combinations of DFT basis groups for PMI reporting. For example, if the network determines that a total of two DFT basis groups are permissible, the CBSR configuration may indicate which specific combinations of two DFT basis groups are permissible out of the total number of O₁×O₂ DFT basis groups.

The CBSR configuration may independently indicate permissible DFT basis groups for each of a plurality of TRPs of the multi-TRP CJT. In other words, the CBSR configuration may separately indicate permissible DFT basis groups for separate TRPs. Alternatively, the one or more permissible DFT basis groups may be permissible for PMI reporting for a subset or potentially for all of the plurality of TRPs of the multi-TRP CJT. For example, the CBSR configuration may indicate a single set of permissible DFT basis groups, and this set may be permissible for the UE in reporting a PMI for all of the TRPs of the multi-TRP CJT.

In still other embodiments, the CBSR configuration may indicate that the UE selects mutually distinct DFT basis groups for different TRPs. For example, the CBSR configuration may indicate a plurality of permissible DFT basis groups (or sets of permissible DFT basis groups), and may further indicate for the UE to report each permissible DFT basis group for only a single TRP, so that each TRP has a distinct set of one or more DFT basis groups reported for it in the PMI.

In addition to or alternatively to indicating permissible DFT basis groups, the CBSR configuration may indicate, for each DFT basis group, one or more permissible DFT bases of the respective DFT basis group. The permissible DFT bases may be indicated in a binary fashion (i.e., as either permitted or not permitted for PMI reporting, e.g., through a bitmap). Alternatively, for each permissible DFT basis, the CBSR configuration may indicate an energy threshold restriction for the respective permissible DFT basis. The energy threshold restriction may indicate that while the UE may report the DFT basis in the PMI, the UE is restricted to receiving transmissions through the corresponding DFT basis beam that do not exceed the indicated energy threshold. Each permissible DFT basis may have its own specific energy threshold. Alternatively, a common multi-bit may be provided in the CBSR configuration that indicates a common energy threshold for all of the permissible DFT bases.

The CBSR configuration may independently indicate permissible DFT bases for each of a plurality of TRPs of the multi-TRP CJT, or a single set of indicated permissible DFT bases may be permissible for PMI reporting for each of the TRPs of the multi-TRP CJT. As a third possibility, the CBSR configuration may restrict the permissible DFT bases for different TRPs to be different. For example, the CBSR configuration may indicate a set of permissible DFT bases, and may further indicate that the UE is to select different ones of the permissible DFT bases for PMI reporting related to each of the different TRPs, so that the reported DFT basis/bases for any given TRP are not the same as those for any other TRP.

In addition or alternatively to including a CBSR configuration, the CSI configuration may include a rank restriction. The rank restriction may indicate one or more ranks that are restricted for PMI reporting for the multi-TRP CJT. In various embodiments, the rank restriction may either indicate ranks that are disallowed for PMI reporting, or alternatively it may indicate ranks that are allowed for PMI reporting. The rank restriction may be a bitmap indicating whether each of a plurality of ranks are restricted. For example, if the bitmap is allocated as {R1, R2, R3, R4}, a bitmap of {0, 0, 1, 1} would indicate to the UE that the cannot report ranks 1 or 2, but can report ranks 3 or 4. Alternatively, the rank restriction may be a bit indicator that indicates a rank value threshold, where ranks larger than the rank value threshold are restricted. For example, when up to 4 ranks are potentially configurable, the rank value threshold may be indicated with a 2-bit indicator, such that {00}, {01}, {10} and {11} correspond to the 4 possible ranks 1-4, and the UE cannot report a rank larger than the indicated rank threshold. As another alternative, the rank value threshold may indicate the minimum rank that may be reported in the PMI. The rank restriction may indicate that the one or more ranks are restricted for each of the TRPs of the multi-TRP CJT, or a separate rank restriction may be provided for each TRP.

For each TRP, the UE may select a rank that is not restricted to report in the PMI. To use the {0, 0, 1, 1} bitmap reporting example given above, in this case the UE may decide to report a preference for rank 4. In this case, for each TRP, and for each of the four layers, the UE reports a PMI. The reported PMIs may be restricted or not restricted according to a CBSR configuration, in various embodiments. The UE may additionally report preferred linear combination coefficients c′ for each TRP and for each layer.

At 806, the UE determines CSI to provide to the base station based at least in part on the CBSR configuration. The CSI may include one or more PMIs, linear combination coefficients c^{t}, and/or other types of uplink control information. Determining the CSI may include selecting one or more first DFT basis groups and/or DFT bases to indicate in the PMI for a first TRP of the multi-TRP CJT. The one or more first DFT basis groups and/or DFT bases are selected from those indicated as permissible for PMI reporting by the CBSR configuration.

At 808, the CSI is provided to the base station. For example, the UE may wirelessly transmit the CSI to the base station through the established wireless link. The CSI may include one or more PMIs, linear combination coefficients c^{t}, and/or other types of uplink control information. The network may then utilize the CSI to determine beamforming parameters for the multiple TRPs in communicating with the UE.

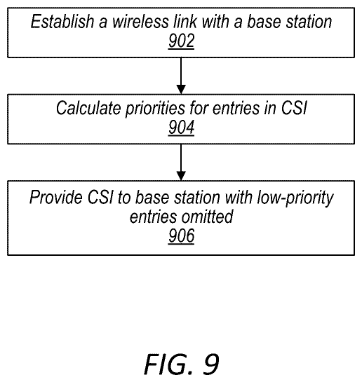

### FIG. 9—Flowchart for Uplink Control Information Omission a Multi-TRP CJT Scenario

FIG. 9 is a flowchart diagram illustrating a method for performing selective uplink control information (UCI) omission in a multi-TRP CJT scenario. Aspects of the method of FIG. 9 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 9 are described in a manner relating to the use of communication techniques and/or features associated with 3GPP and/or NR specification documents, such description is not intended to be limiting to the disclosure, and aspects of the method of FIG. 9 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 9 may operate as follows.

In 902, the wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

At 904, priorities for various components of the CSI are calculated. For example, a respective priority may be calculated for each of a plurality of entries of a precoding matrix indicator (PMI). Channel state information (CSI) may be classified in one of four ways, as either CSI part 1, CSI part 2 group 0, CSI part 2 group 1, or CSI part 2 group 2, where the relative priorities of these four classifications is {CSI part 1>CSI part 2 group 0>CSI part 2 group 1>CSI part 2 group 2} (i.e., CSI part 1 has the highest priority and CSI part 2 group 2 has the lowest priority). The priority that is calculated for the entries of the PMI may be calculated by assigning each entry to one of these four classifications, in some embodiments.

When a UE reports UCI (e.g., by reporting a PMI), the UE may be instructed by the network to omit UCI that is less than a threshold priority level (e.g., during a network congestion scenario). For example, the network may instruct the UE to omit reporting of UCI that is classified as CSI part 2 group 2, or to omit reporting of UCI that is classified as CSI part 2 groups 1 or 2. Embodiments herein present enhancements to PMI entry prioritization that incorporates multiple TRPs in a multi-TRP CJT scenario.

The PMI is constructed by the UE to indicate preferred beamforming matrices to a base station for each of a plurality of TRPs in the multi-TRP CJT scenario. For each of the TRPs, the PMI may include one or more of the W₁, W₂ and/or W_{ƒ} matrices illustrated in FIG. 5, as one non-limiting example. The W₂ matrix may include a large percentage of null (i.e., zero) entries (e.g., more than 50%), and the UE may refrain from reporting these null entries as UCI when it reports the PMI. The calculated priorities at step 904 may be for entries of the PMI that are non-zero entries of W₂ matrices (i.e., for the W₂ matrices for each of the plurality of TRPs).

In some embodiments, calculating priorities for PMI entries is performed based at least in part on respective transmission reception point (TRP) indices, layer indices, spatial basis indices, and/or frequency basis indices associated with the respective non-zero entries of the W₂ matrices. In some embodiments, in calculating the respective priorities for each of the plurality of non-zero entries of the PMI, the layer indices, spatial basis indices, and/or frequency basis indices may be granted a higher consideration than the TRP indices.

In some embodiments, an equation such as the following may be used to calculate the priorities: Pri(l, i, ƒ, t)=2L·RI·T·π(ƒ)+RI·T·i+T·l+t, where a smaller value has a higher priority, and where l=0, . . . , RI−1 is the layer index, i=0, . . . , 2L−1 is the spatial basis index, ƒ=0, . . . , M−1 is the frequency basis index, and t=0, . . . , T−1 is the TRP index. In this equation, the TRP index is given the lowest consideration in determining priority, as the TRP index occurs in the smallest term in the summation. This may be desirable in some cases, as the multiple TRPs may be functionally equivalent or similar such that there is not a strong reason to prioritize PMIs for one TRP over another. Alternatively, this equation may be adjusted, e.g., to the following equation:

$$P r i ( l , i , f , t ) = 2 L \cdot RI \cdot T \cdot π ( f ) + RI \cdot T \cdot i + RI ⋆ t + l$$

In this expression, TRP index is granted higher consideration than the layer index, but smaller consideration than the spatial and frequency basis indices in determining priority. In general, the TRP index may granted any desired degree of consideration (or no consideration) in determining priority.

In some embodiments, the non-zero entries of the W₂ matrices may be divided into two halves based on their determined priorities, where the lower priority half is classified as CSI part 2 group 2 and the higher priority half is classified as CSI part 2 group 1. The PMI may additionally include linear combination coefficients for the different TRPs (i.e., the c^{t} variables described above). The linear combination coefficients may be granted higher priority than the entries of the W₂ matrix of the PMI, in some embodiments. For example, the linear combination coefficients may be granted either CSI part 1 or CSI part 2 group 0 priority, whereas the W₂ matrix entries may be granted CSI part 2 group 1 or CSI part 2 group 2 priority, as one example.

At 906, the CSI is provided to the base station, where components of the CSI with priorities less than a predetermined threshold are omitted (e.g., low priority entries of a PMI). The predetermined threshold may be determined by the network (e.g., by the base station) based on network capacity, network loading, congestion, or other considerations. In some embodiments, the threshold may also be determined based on the available UCI payload size that can be carried in PUSCH (Physical Uplink Shared Channel) or PUCCH (Physical Uplink Control Channel). The base station may have previously transmitted an indication of the predetermined threshold to the UE.

### Additional Information

The following numbered paragraphs provide additional detail on embodiments described herein.

In a multi-TRP CJT scenario, the network (NW) may configure each TRP with up to K DFT basis groups (or equivalently, oversampling groups), where each DFT basis group includes each of N₁*N₂ DFT bases for a single oversampling group, where N₁ and N₂ are the number of V-Pol/H-Pol antenna pairs oriented vertically and horizontally, respectively, of a particular TRP. For each TRP, each of the K oversampling groups may be selected from among O₁*O₂ possibilities, where O₁ and O₂ represent the degree of oversampling for vertical and horizontal polarization, respectively.

In some embodiments, the network may provide a codebook subset restriction (CBSR) configuration to the UE to restrict, for each of the TRPs, the DFT basis group(s) and/or DFT bases within one or more DFT basis groups on which the UE may report in a PMI. In each case (DFT basis group restriction or DFT basis restriction), the network may either a) apply the restriction independently for each of the TRPs, b) apply a single restriction to all of the TRPs, or c) apply a complementary restriction, where the UE is instructed to not select the same DFT basis group (or DFT basis) for two different TRPs (i.e., each TRP will receive a PMI with a disjoint set of DFT basis groups and/or DFT bases).

The size of the CBSR configuration may be estimated in each of these cases as follows.

For DFT basis group restriction, for option a), the total number of bits utilized to communicate the restriction may be estimated as [log₂(C(O1·O2,K))]·T, where Tis the total number of TRPs, and C(n, k) is “n choose k”, i.e., C(n, k)=n!/(k!(n−k)!). For option b), the total number of bits utilized may be estimated as [log₂(C(O1·O2,K))], and for option c) the total number of bits may be estimated as Σ^{T-1}ₜ₌₀ [log₂(C(O1·O2−t·K,K))].

For DFT basis restriction within a DFT basis group, for option a), the total number of bits utilized to communicate the restriction may be estimated as N₁·N₂·B·K·T, where B is equal to 1 when the CBSR configuration includes a binary notification of whether a DFT basis group is restricted or not, and B is greater than 1 when the CBSR specifies an energy threshold for the DFT basis group. For option b), the total number of bits utilized may be estimated as N₁·N₂·B·K, and for option c) the total number of bits may be estimated as N₁·N₂·(B+[log₂(T)])·K.

In the following further exemplary embodiments are provided.

A further exemplary embodiment may include a method, comprising: performing, by a device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising, by a user equipment (UE):
receiving a codebook subset restriction (CBSR) configuration from a base station, wherein the CBSR configuration indicates one or more permissible discrete Fourier transform (DFT) basis groups for precoding matrix indicator (PMI) reporting for multi-transmission reception point (multi-TRP) coherent joint transmission (CJT);
determining a PMI to provide to the base station based at least in part on the CBSR configuration, wherein determining the PMI comprises:
selecting one or more first DFT basis groups to indicate in the PMI for a first TRP of the multi-TRP CJT, wherein the one or more first DFT basis groups are indicated as permissible for PMI reporting by the CBSR configuration; and
providing the PMI to the base station.

2. The method of claim 1,
wherein the CBSR configuration comprises a bitmap indicating permissible combinations of DFT basis groups for PMI reporting.

3. The method of claim 1,
wherein the CBSR configuration independently indicates permissible DFT basis groups for each of a plurality of TRPs of the multi-TRP CJT.

4. The method of claim 1,
wherein the one or more permissible DFT basis groups are permissible for PMI reporting for each of a plurality of TRPs of the multi-TRP CJT.

5. The method of claim 1, wherein determining the PMI further comprises:
selecting one or more second DFT basis groups to indicate in the PMI for a second TRP of the multi-TRP CJT, wherein the one or more second DFT basis groups are indicated as permissible for PMI reporting by the CBSR configuration,
wherein the one or more first DFT basis groups are different from the one or more second DFT basis groups.

6. The method of claim 1,
wherein the CBSR configuration further indicates, for each respective DFT basis group of the one or more permissible DFT basis groups, one or more permissible DFT bases of the respective DFT basis group.

7. The method of claim 6,
wherein the CBSR configuration further indicates, for each permissible DFT basis, an energy threshold restriction for the respective permissible DFT basis.

8. The method of claim 7,
wherein the energy threshold restriction is indicated as a common multi-bit that applies to each of the permissible DFT bases.

9. The method of claim 6,
wherein the CBSR configuration independently indicates permissible DFT bases for each of a plurality of TRPs of the multi-TRP CJT.

10. The method of claim 6,
wherein the one or more permissible DFT bases are permissible for PMI reporting for each of a plurality of TRPs of the multi-TRP CJT.

11. The method of claim 6,
wherein the PMI indicates preferred DFT bases for each of a plurality of TRPs of the multi-TRP CJT, and
wherein the CBSR configuration restricts the permissible DFT bases for each of the plurality of TRPs to be mutually distinct.

12. A user equipment (UE), comprising:
an antenna;
a radio operably coupled to the antenna; and
a processor operably coupled to the radio, wherein the UE is configured to:
receive a codebook subset restriction (CBSR) configuration from a base station, wherein the CBSR configuration indicates one or more permissible DFT bases for precoding matrix indicator (PMI) reporting for multi-transmission reception point (multi-TRP) coherent joint transmission (CJT);
determine a PMI to provide to the base station based at least in part on the CBSR configuration, wherein in determining the PMI, the UE is configured to:
select one or more first DFT bases to indicate in the PMI for a first TRP of the multi-TRP CJT, wherein the one or more first DFT bases are indicated as permissible for PMI reporting by the CBSR configuration; and
provide the PMI to the base station.

13. The UE of claim 12,
wherein the CBSR configuration further indicates, for each permissible DFT basis, an energy threshold restriction for the respective permissible DFT basis,
wherein the energy threshold restriction is indicated as a common multi-bit that applies to each of the permissible DFT bases.

14. The UE of claim 12,
wherein the CBSR configuration independently indicates permissible DFT bases for each of a plurality of TRPs of the multi-TRP CJT.

15. The UE of claim 12,
wherein the one or more permissible DFT bases are permissible for PMI reporting for each of a plurality of TRPs of the multi-TRP CJT.

16. The UE of claim 12,
wherein the PMI indicates preferred DFT bases for each of a plurality of TRPs of the multi-TRP CJT, and
wherein the CBSR configuration restricts the permissible DFT bases for each of the plurality of TRPs to be mutually distinct.

17. An apparatus, comprising:
a processor configured to cause a user equipment (UE) to:
receive a rank restriction configuration from a base station, wherein the rank restriction configuration indicates one or more ranks for precoding matrix indicator (PMI) reporting for multi-transmission reception point (multi-TRP) coherent joint transmission (CJT);
determine a rank indicator (RI) to provide to the base station based at least in part on the rank restriction configuration, wherein the RI indicates a preferred rank, and wherein the preferred rank is selected from the one or more ranks indicated in the rank restriction configuration; and
provide the RI to the base station.

18. The apparatus of claim 17,
wherein the rank restriction configuration comprises a bitmap indicating each of a plurality of ranks.

19. The apparatus of claim 17,
wherein the rank restriction configuration comprises a 2-bit indicator indicating a rank value threshold, wherein the one or more ranks indicated by the rank restriction configuration are larger or smaller than the rank value threshold.

20. The apparatus of claim 17,
wherein the rank restriction configuration indicates the one or more ranks for each of a plurality of TRPs of the multi-TRP CJT.
